(19) United States
(12) Patent Application Publication
(10) Pub. No.: US 2015/0237320 A1
(43) Pub. Date: Aug. 20, 2015

(54) IMAGE PROCESSING APPARATUS AND IMAGE PROCESSING METHOD

(71) Applicant: SAMSUNG DISPLAY CO., LTD., Yongin-City (KR)

(72) Inventors: Seiki TAKAHASHI, Yokohama (JP); Hiroshi OHISHI, Yokohama (JP)

(21) Appl. No.: 14/624,771

(22) Filed: Feb. 18, 2015

(30) Foreign Application Priority Data
Feb. 19, 2014 (JP) 2014-029745

(51) Int. Cl. H04N 9/64; H04N 5/265

(52) U.S. Cl. CPC H04N 9/64; H04N 5/265

(57) ABSTRACT

An image processing apparatus includes a signal input converter, a color gamut converter, a blend coefficient setter, and a color synthesizer. The signal input converter converts input signals having a first color gamut representing image data to first image signals that are at least substantially linear. The color gamut converter converts the first image signals to second image signals having a second color gamut narrower than the first color gamut. The blend coefficient setter sets a blend coefficient corresponding to a synthesis ratio of the first and second image signals based on saturation obtained from the input signals. The color synthesizer generates synthesized image signals obtained by synthesizing the first and second image signals at a ratio according to the set blend coefficient.

### CROSS-REFERENCE TO RELATED APPLICATION

Japanese Patent Application No. 2014-029745, filed on Feb. 19, 2014, and entitled, “Image Processing Apparatus and Image Processing Method,” is incorporated by reference herein in its entirety.

### BACKGROUND

1. Field

One or more embodiments described herein relate to an image processing apparatus and an image processing method.

2. Description of the Related Art

A variety of displays have recently been developed. Examples include liquid crystal displays (LCDs) and organic electroluminescent displays. In these and other types of displays, a color reproduction region of the display has been gradually expanded along with the enhancement in color display technology. For example, a color reproduction region wider than an existing international standard for color reproduction, standard RGB (sRGB), and Adobe RGB has been proposed for an LCD using light emitting diode (LED) backlight or a self-emissive organic EL display.

For example, International Telecommunication Union Radiocommuncation (ITU-R) Recommendation BT 2020 defines a color space for Ultra High Definition Television (UHDTV). According to this Recommendation, image content having a wide color gamut according to a color space for UHDTV may be provided to a display.

When image content having the wide color gamut according to the color space for UHDTV is provided to a display, the display having a typical color gamut, such as an sRGB color space or an Adobe RGB color space, may attempt to generate images having a wider color gamut. When a signal corresponding to a wide color gamut is input to a display having a narrow color gamut, the display may use a color conversion technology in attempt to convert the wide color gamut into the narrow color gamut. However, such a conversion may result in a color reproduction that does not adhere to a standard and/or produces inaccurate or unrealistic color in the generated images.

### SUMMARY

In accordance with one or more embodiments, an image processing apparatus includes a signal input converter to convert input signals having a first color gamut representing image data to first image signals that are at least substantially linear; a color gamut converter to convert the first image signals to second image signals having a second color gamut narrower than the first color gamut, the image signals having the second color gamut to be displayed; a blend coefficient setter to set a blend coefficient corresponding to a synthesis ratio of the first image signals and the second image signals based on saturation obtained from the input signals; and a color synthesizer to generate synthesized image signals obtained by synthesizing the first image signals and the second image signals at a ratio according to the set blend coefficient.

The blend coefficient setter sets an upper bound of saturation based on a color difference between a boundary of the first color gamut and a boundary of the second color gamut and based on a chroma component of the boundary of the first color gamut, and the blend coefficient setter sets the upper bound of saturation when the boundary of the first color gamut and the boundary of the second color gamut are converted into an L*a*b space, the upper bound of saturation corresponding to when synthesized image signals generated by the color synthesizer based on the blend coefficient become the second image signals.

The blend coefficient setter may set the upper bound of saturation according to a quotient, and the quotient may be obtained by dividing the color difference between the boundary of the first color gamut and the boundary of the second color gamut by the chroma component of the boundary of the first color gamut.

The blend coefficient setter may decrease the upper bound of saturation under according to an increase in a quotient, and the quotient may be obtained by dividing the color difference between the boundary of the first color gamut and the boundary of the second color gamut by the chroma component of the boundary of the first color gamut.

A change rate of the upper bound of saturation to the quotient may linearly vary, and, under the upper bound of saturation, the synthesized image signals generated by the color synthesizer based on the blend coefficient may become the second image signals.

Before and after the upper bound of saturation, under which the synthesized image signals generated by the color synthesizer based on the blend coefficient become the first image signals, becomes 0.5, a change rate of the upper bound of saturation, under which the synthesized image signals generated by the color synthesizer based on the blend coefficient become the second image signals, to the quotient may be different.

In accordance with one or more other embodiments, an image processing method includes converting input signals having a first color gamut representing image data to first image signals that are at least substantially linear; converting the first image signals to second image signals having a second color gamut narrower than the first color gamut, the second image signals having the second color gamut to be displayed; setting a blend coefficient corresponding to a synthesis ratio of the first image signals and the second image signals based on saturation obtained from the input signals; and generating synthesized image signals obtained by synthesizing the first image signals and the second image signals at a ratio according to a set blend coefficient. An upper bound of saturation is set based on a color difference between a boundary of the first color gamut and a boundary of the second color gamut and based on a chroma component of the boundary of the first color gamut, and the boundary of the first color gamut and the boundary of the second color gamut are converted into an L*a*b space, the an upper bound of saturation corresponding to when synthesized image signals generated based on the blend coefficient become the second image signals.

In accordance with one or more other embodiments, an image processing apparatus includes a signal input converter to convert input signals having a first color gamut to first image signals; a color gamut converter to convert the first image signals to second image signals having a second color gamut narrower than the first color gamut; a blend coefficient setter to set a blend coefficient corresponding to a synthesis ratio of the first and second image signals based on saturation obtained from the input signals; and a color synthesizer to generate synthesized image signals obtained by synthesizing the first and second image signals at a ratio based on the blend coefficient. The blend coefficient setter sets saturation to a range based on a color difference between a boundary of the first color gamut and a boundary of the second color gamut and based on a chroma component of the boundary of the first color gamut, and the blend coefficient setter sets the saturation range when the boundary of the first color gamut and the boundary of the second color gamut are converted into a predetermined space, the saturation range corresponding to when synthesized image signals generated by the color synthesizer based on the blend coefficient become the second image signals.

### BRIEF DESCRIPTION OF THE DRAWINGS

Features will become apparent to those of skill in the art by describing in detail exemplary embodiments with reference to the attached drawings in which:

FIG. 1 illustrates an embodiment of an image processing apparatus;

FIG. 2A illustrates an example of a difference in color gamut between UHDTV and Adobe RGB, and FIG. 2B illustrates a case where a color reproduction region is not equal to the Adobe RGB standard in FIG. 2A;

FIG. 3 illustrates an example of a blend coefficient α below a first saturation limit;

FIGS. 4A and 4B illustrate an example of a fitting function for the blend coefficient in FIG. 3, and FIG. 4C illustrates examples of values for the fitting function;

FIG. 5 illustrates an embodiment for explaining dE* and C*wc;

FIG. 6 illustrates an embodiment for calculating a second saturation limit;

FIG. 7 illustrates an example of settings for calculating the second saturation limit;

FIG. 8 illustrates an example of Relations for calculating the second saturation limit;

FIG. 9A illustrates a graph of dE*r vs. S2 generated based on Equations 1 and 2 in FIG. 8, and FIG. 9B illustrates a graph of dE*r vs. S2 generated Equations 2 and 3 in FIG. 8;

FIGS. 10A to 10D illustrates examples of how output signals may change according to Relation 2 in FIG. 8 when the color gamut is Adobe RGB;

FIG. 11 illustrates a graph of H value vs. dE*r, S2 values when the color gamut is Adobe RGB;

FIGS. 12A to 12C illustrates examples of how output signals change according to 1a in Relation 1 in FIG. 8 when 0.4 is selected as dE*rmax in an R-rotation of the color gamut for Adobe RGB;

FIGS. 13A to 13C illustrates examples of how output signals change according to 1a in Relation 1 in FIG. 8 when 0.4 is selected as dE*rmax in an L-rotation of the color gamut for Adobe RGB;

FIGS. 14A and 14B illustrate graphs of H value vs. dE*r, S2 values when results of FIGS. 12A to 12C and FIGS. 13A to 13C are obtained;

FIGS. 15A to 15C illustrate how output signals change when S2 is fixed to 0.5 in an R-rotation of the color gamut for Adobe RGB; and

FIGS. 16A to 16C illustrates how output signals Rout, Gout and Bout change when S2 is fixed to 0.5 in an L-rotation of the color gamut for Adobe RGB.

### DETAILED DESCRIPTION

Example embodiments are be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

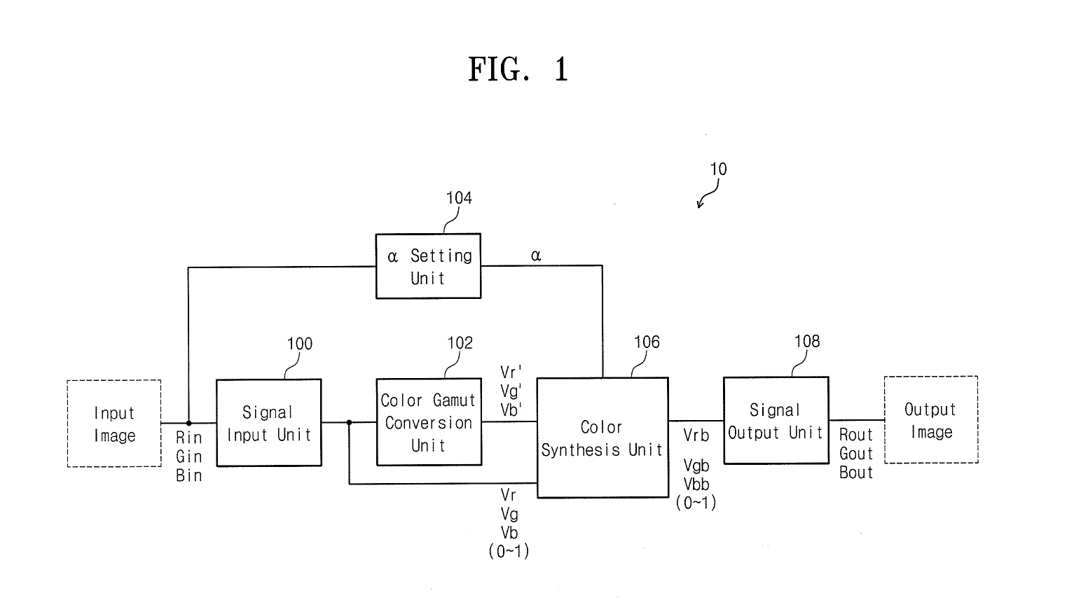

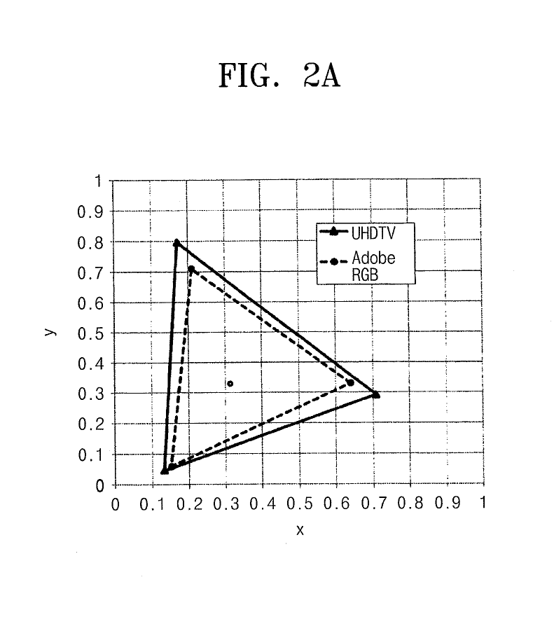

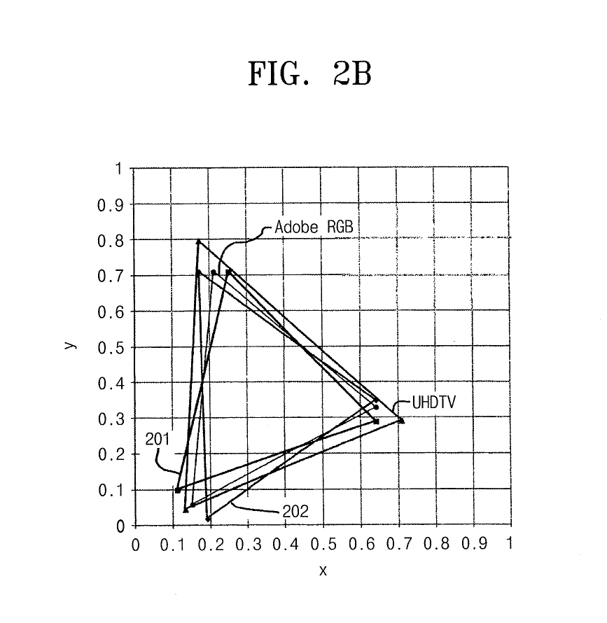

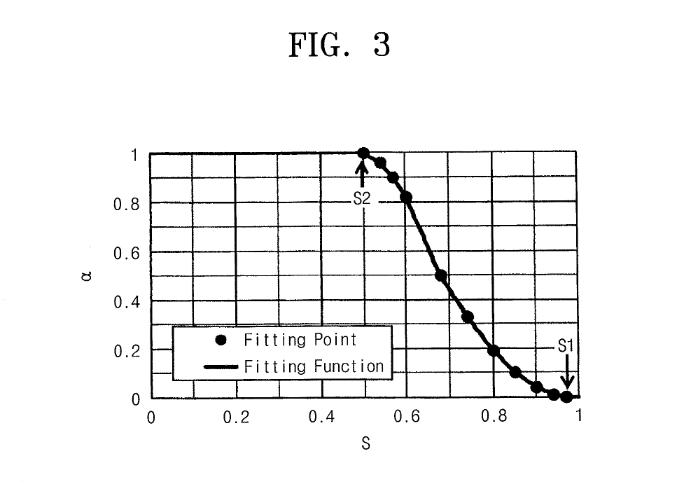

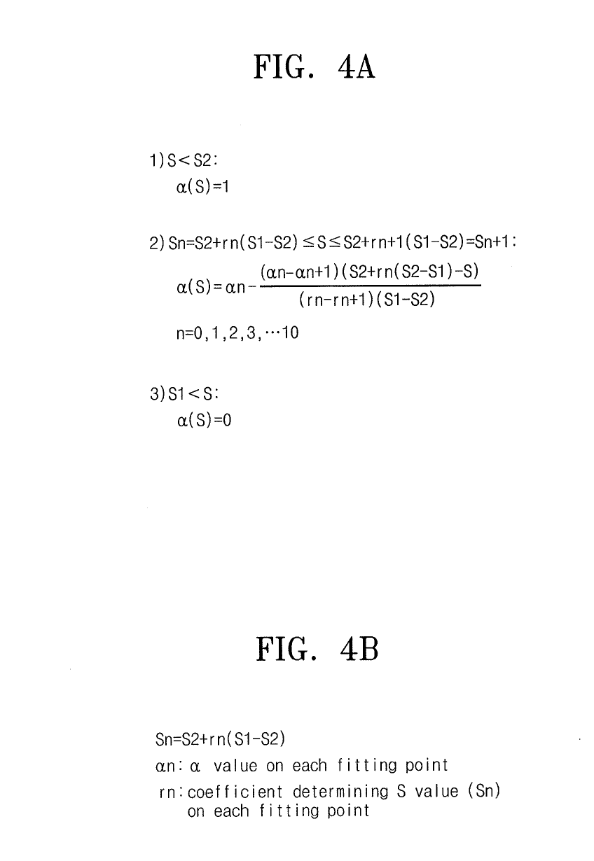

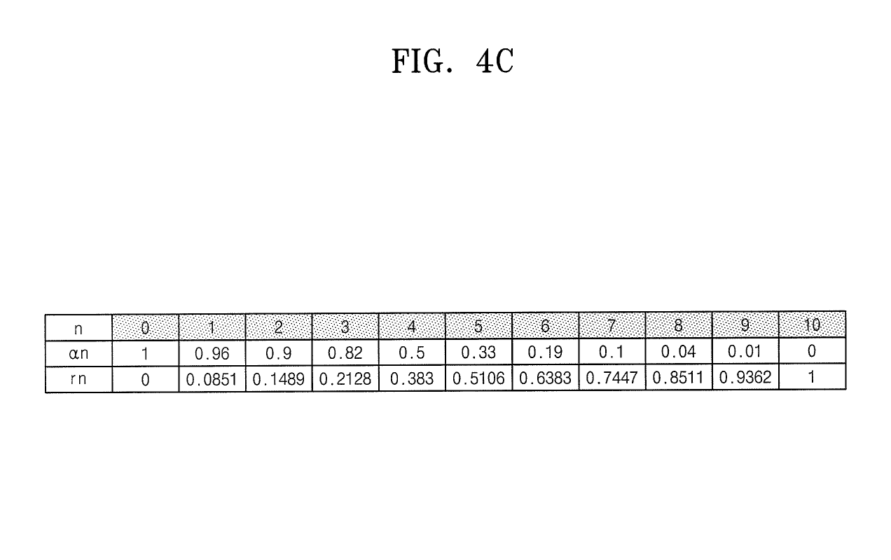

FIG. 1 illustrates an embodiment of an image processing apparatus 10. FIG. 2A illustrates an example of a difference in color gamut between UHDTV and Adobe RGB, and FIG. 2B illustrates examples where color reproduction regions of each display is not equal to the Adobe RGB standard in FIG. 2A. FIG. 3 is a graph representing an example of a level of blend (e.g., blend coefficient α) below a first saturation limit S1 based on a fitting function. FIGS. 4A and 4B are examples of definitions of the fitting function representing the blend coefficient α below the first saturation limit S1 in FIG. 3, and FIG. 4C represents examples of values for defining the fitting function representing the blend coefficient α below the first saturation limit S1 in FIG. 3.

Referring to FIGS. 1 to 4, an image processing device 10 includes a signal input unit 100, a color gamut conversion unit 102, an a setting unit (e.g., blend coefficient setting unit) 104, a color synthesis unit 106, and a signal output unit 108.

The signal input unit 100 receives input signals Rin, Gin, and Bin that are input images. The input signals Rin, Gin, and Bin may be expressed by numerical values in a predetermined range, e.g., 0 to 1. The signal input unit 100 performs exponential function conversion on each of received input signals Rin, Gin, and Bin to generate linear image signals Vr, Vg, and Vb.

The linear image signals Vr, Vg, and Vb may be calculated based on Equation 1. For example, when the input signals Rin, Gin, and Bin conform to a sRGB color space, a gamma γ value is 2.2. Thus, it is possible to generate image signals Vr, Vg, and Vb by raising the input signals Rin, Gin, and Bin to the 2.2^{nd} power.

The image signals obtained by raising the input signals Rin, Gin, and Bin to the gamma γ value power are linear image signals Vr, Vg, and Vb.

$$( \begin{matrix}Vr \\ Vg \\ Vb\end{matrix} ) = ( \begin{matrix}{( Rin / 255 )}^{γ} \\ {( Gin / 255 )}^{γ} \\ {( Bin / 255 )}^{γ}\end{matrix} ) \qquad ( 1 )$$

The color gamut conversion unit 102 uses a conversion matrix to convert the image signals Vr, Vg, and Vb generated at the signal input unit 100 into image signals having a narrow color gamut.

When a color gamut is converted from UHDTV into Adobe RGB, image signals are converted into image signals having a narrow color gamut. In any case, whenever the characteristic of a display does not match an Adobe RGB color gamut, the color gamut of the image signals may be converted.

In a display device having a narrow color gamut, the color gamut conversion unit 102 uses a conversion matrix to convert an image having a wide color gamut into an image having a narrow color gamut. Image signals Vr′, Vg′ and Vb′ obtained through conversion are then output. For example, when [Mwc] is a wide color gamut conversion matrix, [Mnc] is a narrow color gamut conversion matrix, and [Mc]=[Mnc]⁻¹ [Mwc], Equations (2) and (3) are performed:

$$\begin{matrix}( \begin{matrix}X \\ Y \\ Z\end{matrix} ) = [ Mwc ] ( \begin{matrix}Vr \\ Vg \\ Vb\end{matrix} ) = [ Mnc ] ( \begin{matrix}{Vr}^{′} \\ {Vg}^{′} \\ {Vb}^{′}\end{matrix} ) & ( 2 ) \\ ( \begin{matrix}{Vr}^{′} \\ {Vg}^{′} \\ {Vb}^{′}\end{matrix} ) = {[ Mnc ]}^{- 1} [ Mwc ] ( \begin{matrix}Vr \\ Vg \\ Vb\end{matrix} ) = [ M c ] ( \begin{matrix}Vr \\ Vg \\ Vb\end{matrix} ) & ( 3 )\end{matrix}$$

In ITU-R Recommendation BT 2020, an UHDTV color gamut is a wide color gamut, an Adobe RGB color gamut is a narrow color gamut, and a color gamut conversion operation in such a case is exemplarily described.

Table 1 represents examples of CIE xy coordinate values of each of UHDTV and Adobe RGB, and FIG. 2A is an example of a CIE xy chromacity diagram for each of UHDTV and Adobe RGB. A white color W has the same value. As shown in FIG. 2A, the UHDTV color gamut has a wider color gamut than an Adobe RGB color gamut.

When at least one of the coordinate points of R, G and B values on the CIE xy chromacity diagram or the CIE xy coordinate values is inside a wide color gamut coordinate, it is defined as a narrow color gamut. For example, when the boundary of the color gamut is inside the wide color gamut, it may be defined as a narrow color gamut. Conversely, when, for example, a color coordinate corresponding to B on the CIE xy chromacity diagram is outside UHDTV but color coordinates corresponding to R and G are inside the UHDTV, it is defined as a narrow color gamut.

TABLE 1

| | |
|---|---|
| UHDTV | Adobe RGB |

| | x | y | x | y |
|---|---|---|---|---|
| R | 0.708 | 0.292 | 0.640 | 0.330 |
| G | 0.170 | 0.797 | 0.210 | 0.710 |
| B | 0.131 | 0.046 | 0.150 | 0.060 |
| W | 0.3127 | 0.329 | 0.3127 | 0.329 |

Tables 2 to 4 represent examples of conversion matrices of UHDTV and Adobe RGB and [Mc] for Equation (3) above.

TABLE 2

| | | |
|---|---|---|
| 0.6361 | 0.1450 | 0.1694 |
| 0.2624 | 0.6785 | 0.0592 |
| 0.0001 | 0.0284 | 1.0606 |

TABLE 3

| | | |
|---|---|---|
| 0.5787 | 0.1856 | 0.1882 |
| 0.2973 | 0.6274 | 0.0753 |
| 0.0270 | 0.0707 | 0.9913 |

TABLE 4
[Mc] = [Mnc]⁻¹ [Mwc]

| | | |
|---|---|---|
| 1.1503 | −0.0971 | −0.0532 |
| −0.1243 | 1.1334 | −0.0091 |
| −0.0224 | −0.0496 | 1.0720 |

The α setting unit 104 sets the blend coefficient α based on saturation S that may be obtained from input signals Rin, Gin, and Bin. The blend coefficient α defines the synthesis ratio of the image signals Vr, Vg, and Vb and the image signals Vr′, Vg′, and Vb′ synthesized at the color synthesis unit 106.

In one embodiment, the blend coefficient α is set so as not to cause an overflow state in which a synthesized image signal is not included in the range of 0 to 1. Depending on the synthesis ratio, when the blend coefficient α is 1, the image signals Vr′, Vg′, and Vb′ become 100%. When the blend coefficient α is 0, the image signals Vr, Vg, and Vb become 100%.

When the image signals Vr′, Vg′ and Vb′ after color conversion correspond to the boundary of a color gamut, the α setting unit 104 may previously examine how input RGB data is distributed in an HSV color space, and may then determine the blend coefficient. In this example, an image display apparatus having a narrow color gamut performs the inverse conversion of a conversion matrix for displaying a wide color gamut, performs exponential function conversion, finds R, G, and B data, and calculates HSV values.

In addition, the α setting unit 104 defines the values of brightness V and/or saturation S that may avoid overflow, and sets the blend coefficient α to a different value depending on whether the brightness V and the saturation S are equal to or larger than defined values S1 and V1 or smaller than them.

The α setting unit 104 sets the blend coefficient α to 0 when the values of brightness V and/or saturation S are equal to or larger than defined values S1 and V1, and sets the blend coefficient α to a value between 0 and 1 when they are smaller than the defined values S1 and V1.

The α setting unit 104 may also use a function to set α so that α changes between 0 and 1, when brightness V and/or saturation S are less than the defined values S1 and V1. For example, in the relationship between saturation S and α, when α is less than S1, α may be set using an exponential function, a linear function, a sigmoid function, or a fitting function. Also, in the relationship between brightness V and α, α less than V1 may be set using a linear function.

The color synthesis unit 106 synthesizes the image signals Vr, Vg, and Vb generated at the signal input unit 100 and the image signals Vr′, Vg′, and Vb′ generated at the color gamut conversion unit 102 at a synthesis ratio according to the blend coefficient α set at the blend coefficient setting unit 104. In this example, α decreases when the image signals Vr′, Vg′, and Vb′ overflow and α increases when they do not overflow. The color synthesis unit 106 generates and outputs synthesized image signals Vrb, Vgb and Vbb. For example, the color synthesis unit 106 blends obtained image signals Vr, Vg, and Vb and image signals Vr′, Vg′, and Vb′ using the blend coefficient α and generates synthesized image signals Vrb, Vgb and Vbb. The synthesized image signals Vrb, Vgb, and Vbb may be found, for example, using the Equations (4) to (6).

Vrb=(1−α)Vr+αVr′ (4)

Vgb=(1−α)Vg+αVg′ (5)

Vbb=(1−α)Vb+αVb′ (6)

When α is 1, the synthesized image signals Vrb, Vgb, and Vbb become the image signals Vr′, Vg′, and Vb′. When α is 0, the synthesized image signals Vrb, Vgb, and Vbb become the image signals Vr, Vg, and Vb. When α is greater than 0 and less than 1, the synthesized image signals Vrb, Vgb, and Vbb are set to values obtained by splitting the image signals Vr, Vg, and Vb and the image signals Vr′, Vg′ and Vb′ according to the ratio of α.

The signal output unit 108 receives the synthesized image signals Vrb, Vgb, and Vbb from the color synthesis unit 106. The signal output unit 108 performs exponential function conversion on the synthesized image signals Vrb, Vgb, and Vbb to generate output signals Rout, Gout and Bout. For example, 1/2.2 exponential function conversion is performed on the synthesized image signals Vrb, Vgb, and Vbb and a required number of bits of signals Rout, Gout, and Bout are generated. The output signals Rout, Gout, and Bout are provided to image display apparatuses such as a display and projector.

In an sRGB color space, the gamma value γ is 2.2. Thus, the output signals Rout, Gout, and Bout may be generated based on Equation 7.

$$( \begin{matrix}Rout \\ Gout \\ Bout\end{matrix} ) = ( \begin{matrix}255 {( Vrb )}^{1 / γ} \\ 255 {( Vgb )}^{1 / γ} \\ 255 {( Vbb )}^{1 / γ}\end{matrix} ) \qquad ( 7 )$$

An embodiment of a method for setting the value of α based on a fitting function when saturation is less than S1 will now be described. For example, the lower bound S1 of saturation S making the value of a zero and the upper bound S2 of saturation S making the value of α one are determined. That is, when the value of saturation S is less than S2, the value of a becomes 1. When the value of saturation S exceeds S1, the value of a becomes 0.

When the value of saturation S is S1 to S2, it is possible to determine fitting points represented by a plurality of round points to determine the value of α using a fitting function passing through the points when the value of saturation S is S1 to S2, as represented in FIG. 3.

When the value of a for the value of saturation S is denoted by α(S), α(S) may be determined based on a fitting function by ten fitting points as represented in FIG. 4A. Also, αn and rn in FIG. 4A respectively are values determining the value of α on each fitting point and the S value Sn on each fitting point, and Sn is defined as S2+rn (S1−S2), as in FIG. 4B Examples of the numerical values of an and rn are in FIG. 4C.

In FIG. 2B, the reference numeral 201 illustrates an example of a color reproduction region R-rotation, rotating right the color reproduction region of Adobe RGB about a whiter point. The reference numeral 202 illustrates an example of a color reproduction region L-rotation, rotating left the color reproduction region of Adobe RGB about the whiter point. In this example, the CIE xy coordinate values of R, G, and B of each of the color reproduction region of Adobe RGB, R-rotation, and L-rotation are represented in Table 5.

TABLE 5

| | R | | G | | B | |
|---|---|---|---|---|---|---|
| | x | y | x | y | x | y |
| Adobe RGB | 0.64 | 0.33 | 0.21 | 0.71 | 0.15 | 0.06 |
| R-Rotaion | 0.64 | 0.29 | 0.25 | 0.71 | 0.11 | 0.10 |
| L-Rotaion | 0.64 | 0.35 | 0.17 | 0.71 | 0.19 | 0.02 |

An example of the conversion matrix [Mnc] between UHDTV and R-rotation is represented in Table 6.

TABLE 6
[Mnc]:

| | | |
|---|---|---|
| 0.6005 | 0.2122 | 0.1378 |
| 0.2721 | 0.6027 | 0.1252 |
| 0.0657 | 0.0340 | 0.9894 |

An example of [Mc]=[Mnc]⁻¹[Mwc] is represented in Table 7.

TABLE 7
[Mc] = [Mnc]⁻¹ [Mwc]:

| | | |
|---|---|---|
| 1.0920 | −0.1863 | 0.0943 |
| −0.0424 | 1.2093 | −0.1669 |
| −0.0710 | −0.0008 | 1.0718 |

An example of the conversion matrix [Mnc] between UHDTV and L-rotation is represented in Table 8.

TABLE 8
[Mnc]:

| | | |
|---|---|---|
| 0.5573 | 0.1606 | 0.2326 |
| 0.3048 | 0.6708 | 0.0245 |
| 0.0087 | 0.1134 | 0.9670 |

An example of [Mc]=[Mnc]⁻¹[Mwc] is represented in Table 9.

TABLE 9
[Mcn] = [Mnc]⁻¹ [Mwc]:

| | | |
|---|---|---|
| 1.1823 | 0.0054 | −0.1876 |
| −0.1458 | 1.0116 | 0.1341 |
| 0.0064 | −0.0896 | 1.0832 |

When the characteristic of an image display apparatus conforms to an Adobe RGB color space and a color gamut in which an image is displayed varies, a unnatural color change may occur when the α value is determined according to the above-described fitting function for performing color gamut conversion.

An embodiment of a method for calculating α to prevent an unnatural color change involves the α setting unit 104 storing an index that is dE*r and based on dE* and C*wc. For example, information on quotient dE*/C*wc obtained by dividing dE* by C*wc is stored in the α setting unit 104. In this example, when brightness and saturation are 1s, dE* and C*wc are values that may be obtained by converting the boundary Bwcg of the wide color gamut of an input image signal (e.g., UHDTV color gamut) and the boundary Bncg of the narrow color gamut of a display apparatus (e.g., R-ration or L-rotation) into an L*a*b color space.

In this example, the L*a*b* color space is a CIE 1976 color space. A CIE XYZ color space may be converted into the L*a*b* color space by letting, the coordinate values of CIE XYZ of a white point being a reference point, be Xn, Yn and Zn and using L*=116f(Y/Yn)−16, a*=500(f(X/Xn)−f(Y/Yn)), and b*=200(f(Y/Yn)−f(Z/Zn)). Also, f(t) is defined as t^{1/3} where t>(6/29)³, and as (1/3)(29/6)²t+4·29 where t (6/29)³.

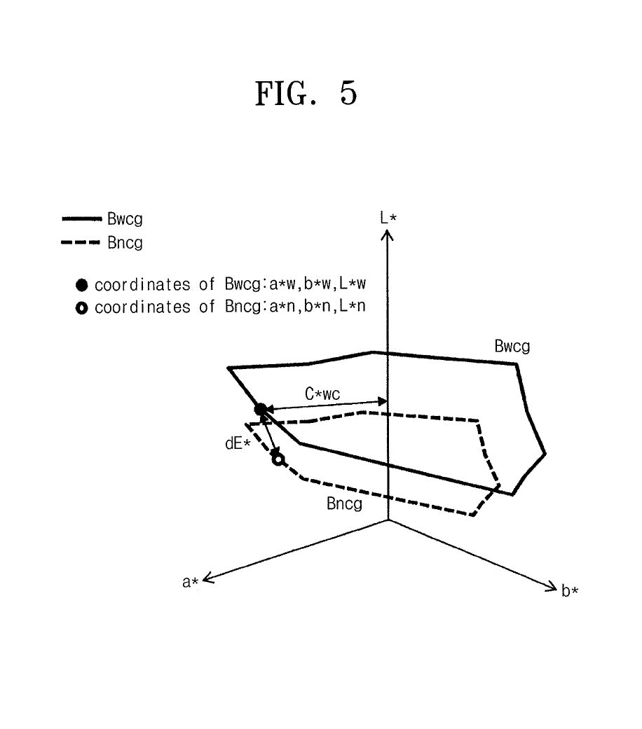

FIG. 5 illustrates an embodiment for explaining dE* and C*wc, with the boundaries Bwcg and Bncg in the L*a*b* color space. Referring to FIG. 5, dE* denotes the color difference between the boundaries Bwcg and Bncg for determined hue H, and may be defined as ((a*w−a*n)²+(b*w−b*n)²+(L*w−L*n)²)^{1/2}. In this example, the coordinates of the boundary Bwcg for the hue H are (L*w, a*w, and b*w) and the coordinates of the boundary Bncg are (L*n, a*n, and b*n). Also, C*wc is the Chroma component of the boundary Bwcg for the hue H and is particularly defined as (a*w²+b*w²)^{1/2}. The α setting unit 104 calculates the second limit S2, that is the upper bound S2 of saturation S by making the α value 1, according to the value dE*r.

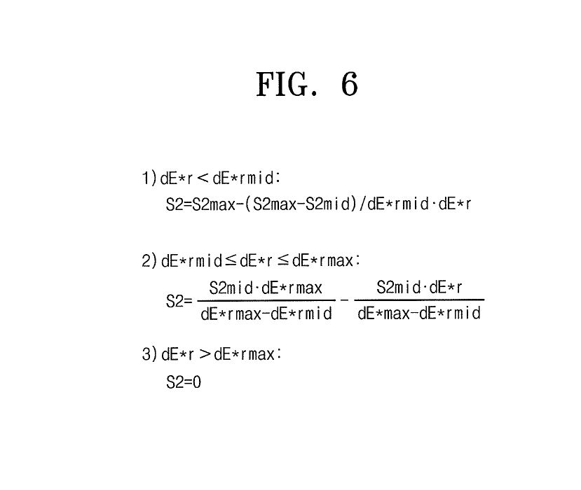

FIG. 6 illustrates examples of equations for calculating the second limit of the saturation in accordance with one embodiment, e.g., FIG. 6 represents an example of calculating S2.

Referring to FIG. 6, dE*rmax and dE*rmid satisfy 0<dE*rmid<dE*rmax. In each of the cases 1) dE*r<dE*rmid, 2) dE*rmid<=dE*r<=dE*rmax, and 3) dE*r>dE*rmax, the numerical value of S2 is calculated. When the saturation S is less than S2, the α value is 1, when the saturation S is equal to or larger than S2 and less than S1, the α value is a value determined by, for example, the above-described fitting function. When the saturation S exceeds S2, the α value is zero. It is also possible to determine dE*rmax and dE*rmid to be the maximum value of S2 and dE*r corresponding to 0.5, respectively.

S2 may be calculated and the α value may be calculated, for example, as represented in FIG. 6. When there is a significant difference in color gamut between the boundaries Bwcg and Bncg (e.g., above a predetermined value), S2 is calculated to be small and the blend ratio of the image signals Vr′, Vg′, and Vb′ may decrease.

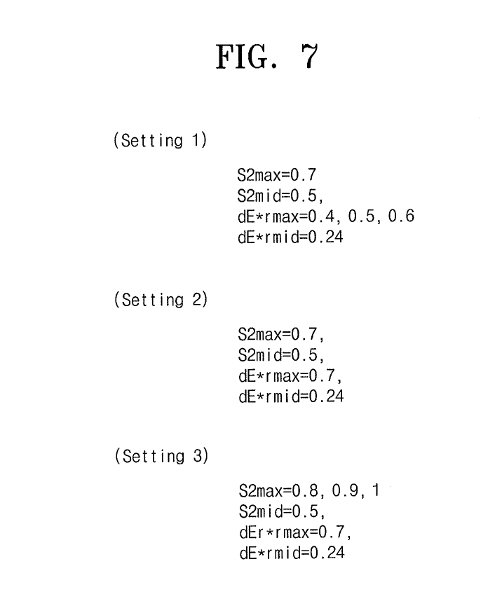

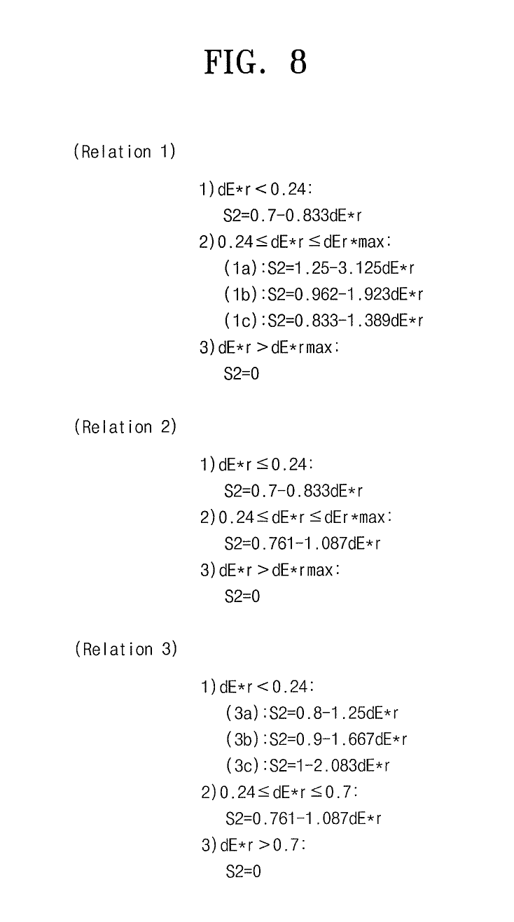

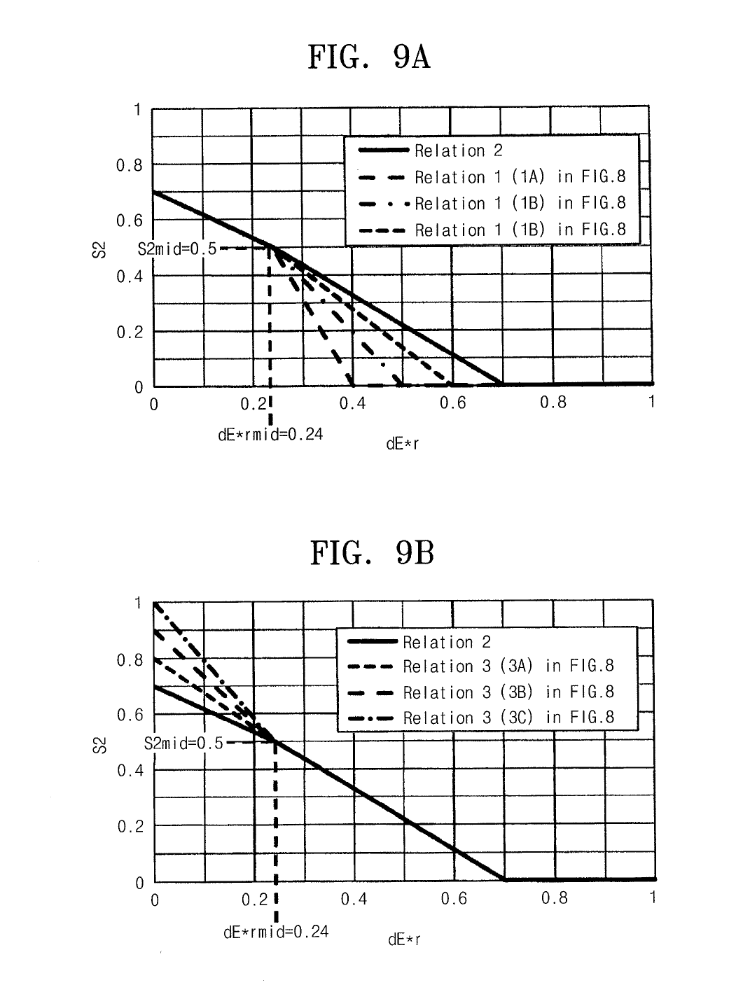

FIG. 7 illustrates an embodiment of a setting for calculating the second limit of the saturation. FIG. 8 illustrates equations for calculating the second limit of the saturation. FIG. 9A is a graph illustrating an example of a relationship dE*r vs. S2 based on Relations 1 and 2 in FIG. 8. FIG. 9B is a graph illustrating an example of dE*r vs. S2 based on Relations 2 and 3 in FIG. 8.

Referring to FIGS. 7 to 9B, in Setting 1 in FIG. 7, the maximum value of S2 is set to about 0.7 and values 0.4, 0.5, and 0.6 are selected as dE*rmax. Also, in Setting 1 in FIG. 7, dE*rmid corresponding to the S2 value, 0.5 is set to 0.24. By applying Setting 1 in FIG. 7 to the calculation of S2 represented in FIG. 6, S2 regarding the dE*r value is calculated as represented by Relation 1 in FIG. 8. In ^{┌}2)_{┘} of Relation 1 in FIG. 8, 1a corresponds to when dE*rmax is 0.4, 1b corresponds to when dE*rmax is 0.5, and 1c corresponds to when dE*rmax is 0.6.

In Setting 2 in FIG. 7, the maximum value of S2 is set to 0.7, 0.7 is selected as dE*rmax, and dE*rmid corresponding to the S2 value, 0.5 is set to 0.24. By applying Setting 2 in FIG. 7 to the calculation of S2 represented in FIG. 6, S2 regarding the dE*r value is calculated as represented by Relation 2 in FIG. 8.

When the relationship between dE*r and S2 by Relation 1 in FIG. 8 and Relation 2 in FIG. 8 is represented by a graph, FIG. 9A is obtained. As such, S2 linearly decreases with an increase in dE*r, but its slope varies between when dE*r is equal to or larger than dE*rmid and when dE*r is less than or equal to dE*rmid.

When dE*r is equal to or greater than dE*rmid in Setting 1 in FIG. 8, the slope (tilt) at which S2 decreases is steeper than that of (Relation 2) FIG. 8 with an increase in dE*r. Thus, when there is a significant difference between a wide color gamut and a narrow color gamut, it is possible to sharply decrease S2 with an increase in dE*r. In a level in which S2 decreases, 1a is largest, 1b is less than 1b, and 1c is less than 1b.

In Setting 3 in FIG. 7, the maximum value of S2 is set to any one of 0.8, 0.9, or 1, and dE*rmax is selected to be 0.7. Also, in Setting 3 in FIG. 7, dE*rmid corresponding to the S2 value, 0.5 is set to 0.24.

By applying Setting 3 in FIG. 7 to the calculation of S2 in FIG. 6, S2 regarding the dE*r value is calculated as represented by Relation 3 in FIG. 8. In ^{┌}1)_{┘} of Relation 1 in FIG. 8, 3a corresponds to when the maximum value of S2 is 0.8, 3b corresponds to when the maximum value of S2 is 0.9, and 3c corresponds to when the maximum value of S2 is 1.

When the relationship between dE*r and S2 by Relation 2 in FIG. 8 and Relation 3 in FIG. 8 is represented by a graph, FIG. 9B is obtained. As such, S2 linearly decreases with an increase in dE*r, but its slope varies between when dE*r is equal to or greater than dE*rmid and when dE*r is less than or equal to dE*rmid.

When dE*r is less than or equal to dE*rmid in Relation 3 in FIG. 8, the slope (tilt) at which S2 decreases is steeper than that of (Relation 2) FIG. 8 with an increase in dE*r. Thus, when there is a small difference between a wide color gamut and a narrow color gamut, it is possible to sharply increase S2 with a decrease in dE*r. In a level in which S2 increases, 3c is largest, 3b is less than 3a, and 3a is less than 3b.

In one example, input signals Rin, Gin, and Bin having H fixed and having S varied from 0 to 1 are input to an image processing apparatus, a simulation result of changes in signals Rout, Gout, and Bout output by the signal output unit 108 is represented, and an effect according to one embodiment is described. In this example, RGB is 8 bit data and V is fixed to 0.7. For example, the maximum values of the input signals Rin, Bin, and Gin are 178.

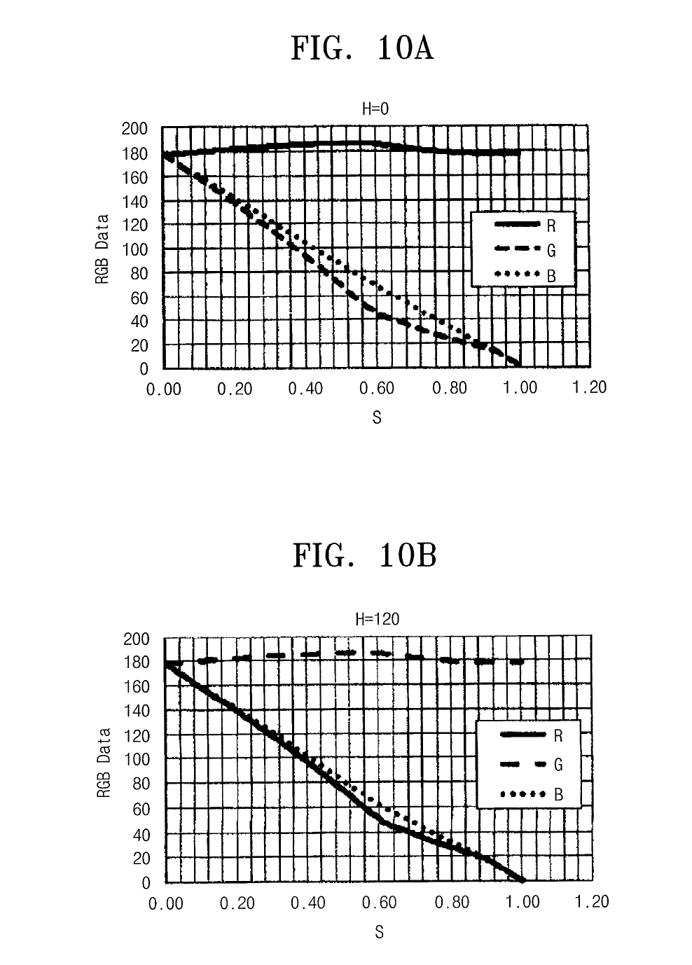

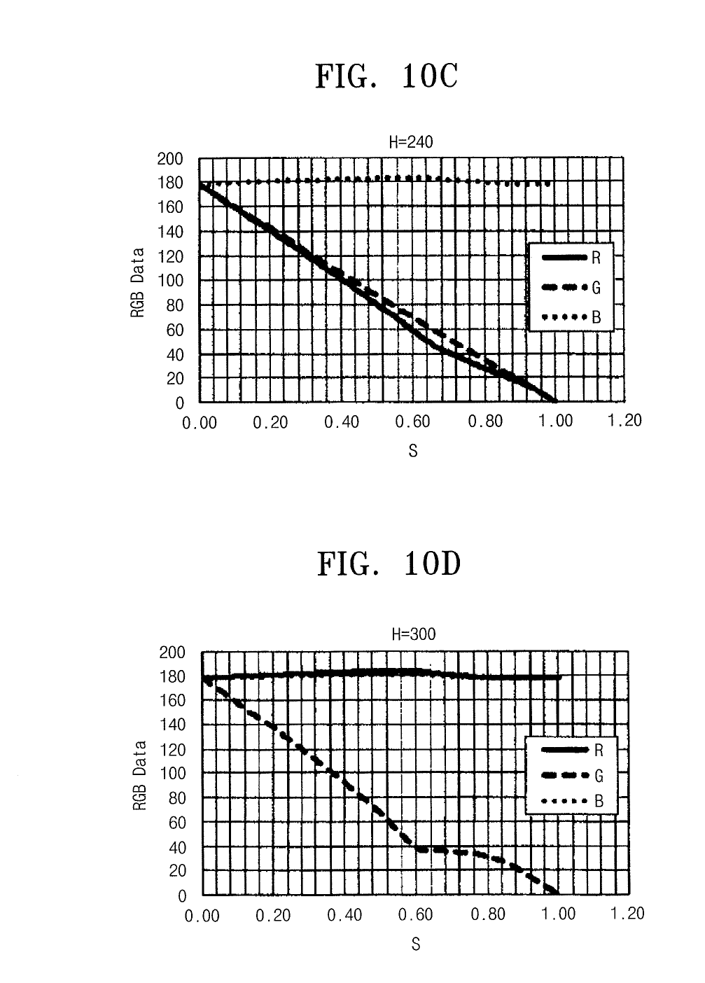

FIGS. 10A to 10D show examples of changes in output signals according to Relation 2 in FIG. 8 when the color gamut of a display apparatus is Adobe RGB. FIG. 10A represents changes in input signals Rin, Gin, and Bin when H is 0. FIG. 10B represents changes in input signals Rin, Gin, and Bin when H is 120°. FIG. 10C represents changes in input signals Rin, Gin, and Bin when H is 240°. FIG. 10D represents changes in input signals Rin, Gin, and Bin when H is 300°. Referring to FIGS. 10A to 10D, output signals Rout, Gout, and Bout make a substantially monotonous change in response to a change in S and do not make a unnatural change.

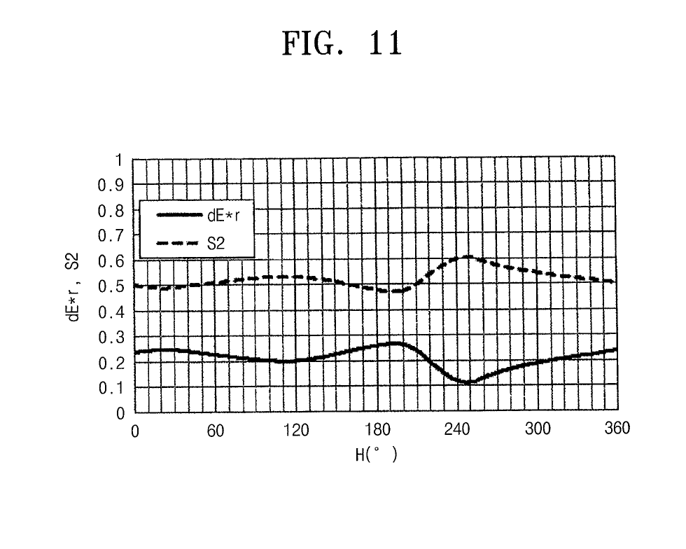

FIG. 11 is a graph illustrating an example of a relationship of H value vs. dE*r, S2 values when the color gamut of a display apparatus is Adobe RGB. Referring to FIG. 11, the value of dE*r is averaged within a range in which H is +/−20°, in order to remove the influence of the sharp change in dE*r to H on an image display

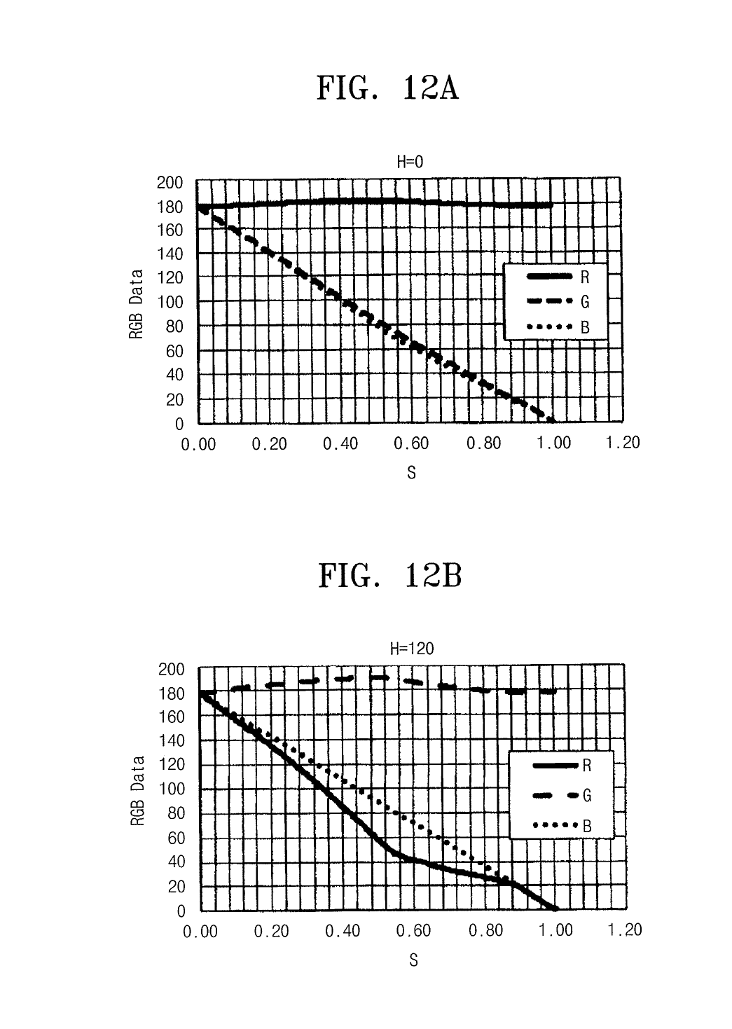

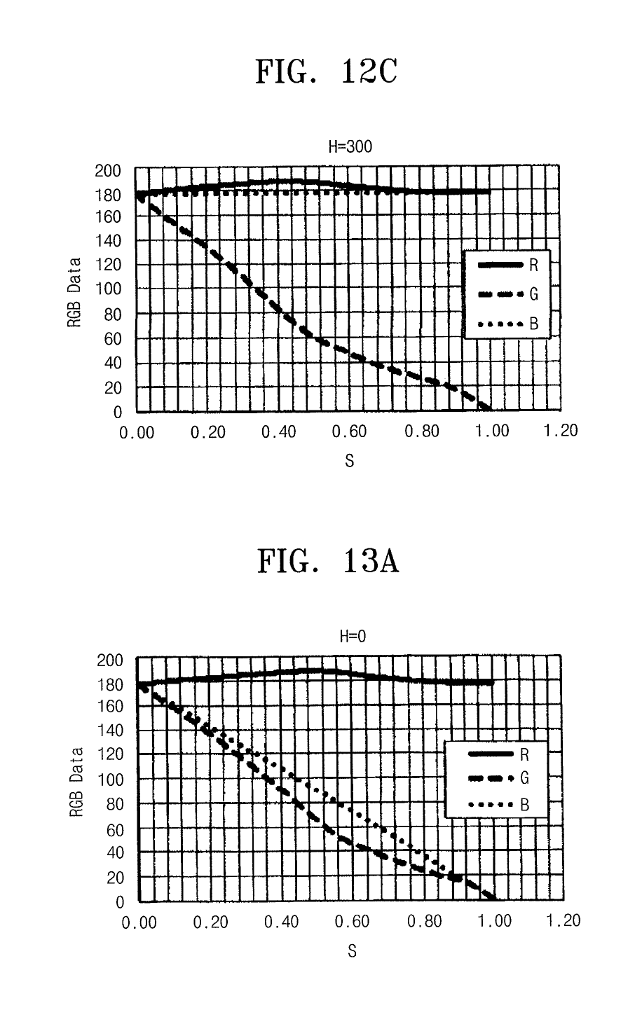

FIGS. 12A to 12C show a example of changes in output signals according to 1a in Relation 1 in FIG. 8 when 0.4 is selected as dE*rmax in R-rotation that the color gamut of a display apparatus rotates right from Adobe RGB. FIG. 12A represents changes in input signals Rin, Gin, and Bin when H is 0. FIG. 12B represents changes in input signals Rin, Gin, and Bin when H is 120°. FIG. 12C represents changes in input signals Rin, Gin, and Bin when H is 300°. Referring to FIGS. 12A to 12C, output signals Rout, Gout, and Bout make a substantially monotonous change in response to a change in S and do not make a unnatural change.

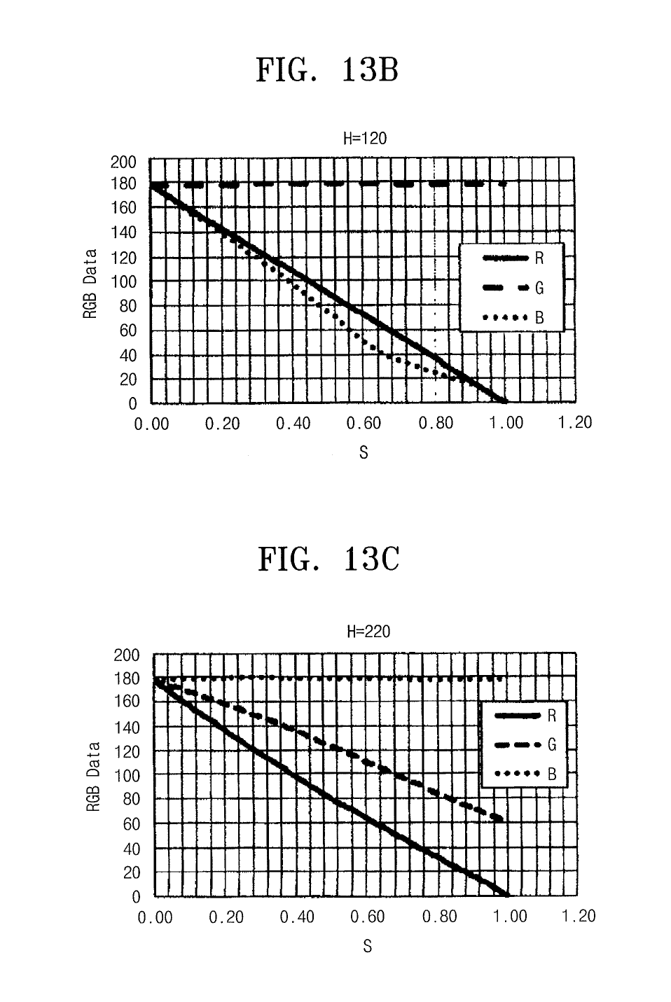

FIGS. 13A to 13C show an example of changes in output signals according to 1a in Relation 1 in FIG. 8 when 0.4 is selected as dE*rmax in L-rotation that the color gamut of a display apparatus rotates left from Adobe RGB. FIG. 13A represents changes in input signals Rin, Gin, and Bin when H is 0. FIG. 13B represents changes in input signals Rin, Gin, and Bin when H is 120°. FIG. 13C represents changes in input signals Rin, Gin, and Bin when H is 220°. Referring to FIGS. 13A to 13C, output signals Rout, Gout and Bout make a substantially monotonous change in response to a change in S and do not make a unnatural change.

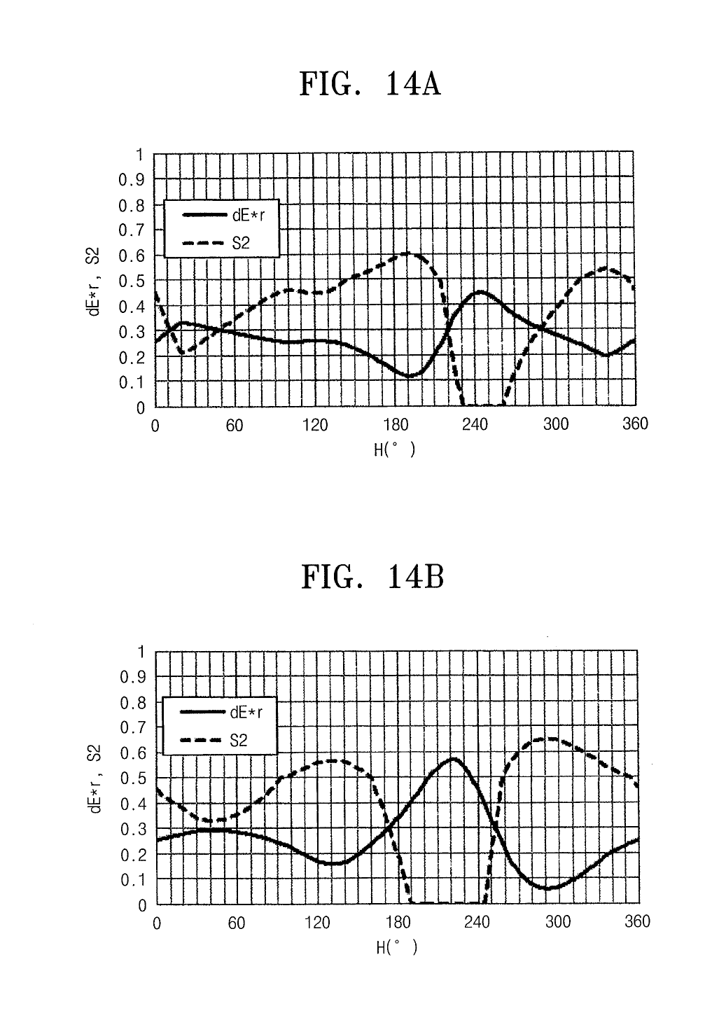

FIGS. 14A and 14B are graphs illustrating an example of H value vs. dE*r, S2 values when results of FIGS. 12A to 12C and FIGS. 13A to 13C are obtained. Referring to FIGS. 14A and 14B, the value of dE*r is averaged within a range in which H is +/−20°, in order to remove the influence of the sharp change in dE*r to H on an image display. When dE*r increases, S2 sharply decreases and thus becomes zero.

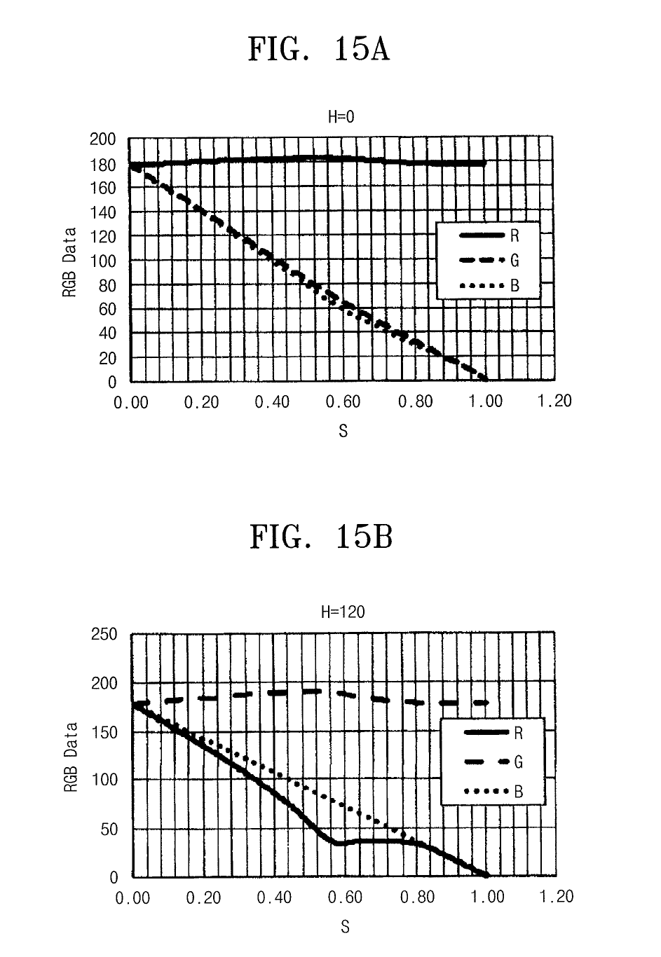

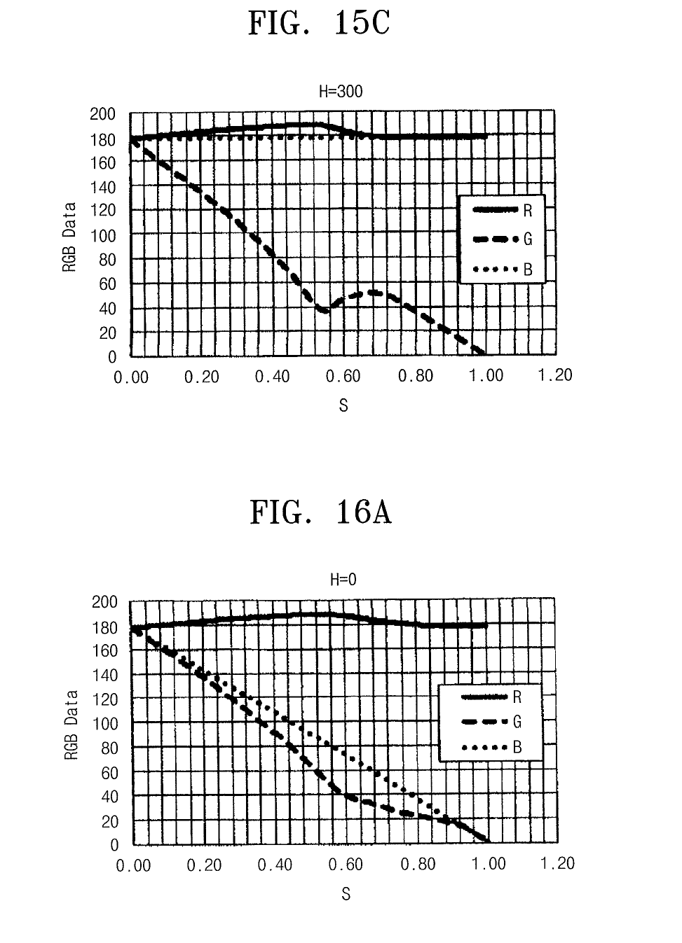

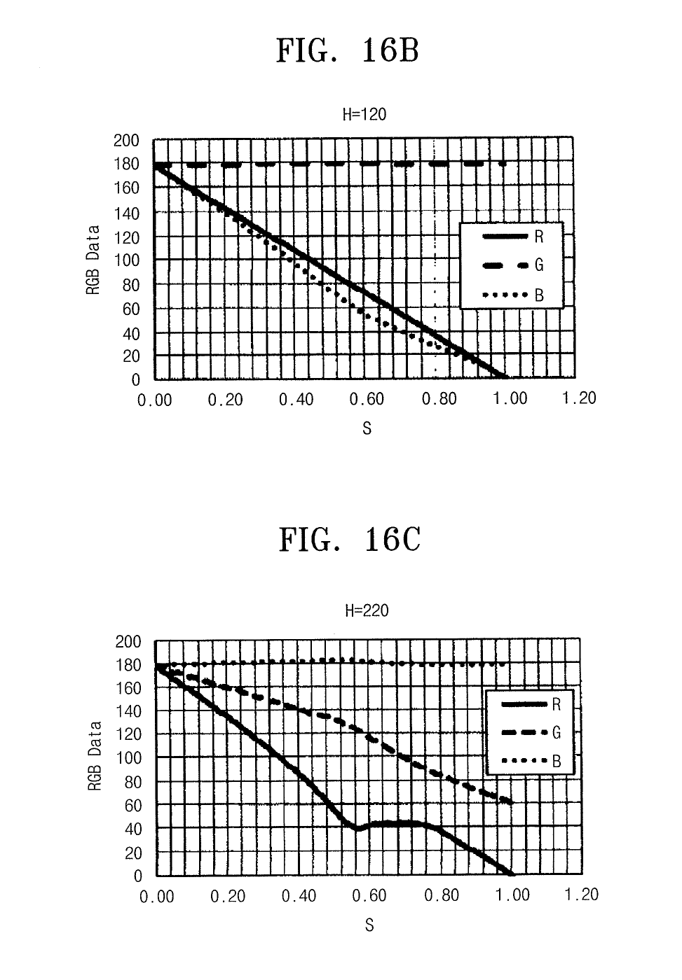

FIGS. 15A to 15C illustrate an example of changes in output signals when S2 is fixed to 0.5, in R-rotation that the color gamut of a display apparatus rotates right from Adobe RGB. FIG. 15A represents changes in input signals Rin, Gin, and Bin when H is 0. FIG. 15B represents changes in input signals Rin, Gin, and Bin when H is 120°. FIG. 15C represents changes in input signals Rin, Gin, and Bin when H is 300°. As shown in FIGS. 15B and 15C, a unnatural color change greater than that of FIGS. 12B and 12C is observed. The reason is because S2 in FIGS. 12A to 12C is set to 0.45 when H is 120°, to 0.38 when H is 300°, and to a value less than 0.5, as could be seen from FIG. 14A. FIGS. 16A to 16C illustrate an example of changes in output signals Rout, Gout and Bout when S2 is fixed to 0.5, in L-rotation that the color gamut of a display apparatus rotates left from Adobe RGB. FIG. 16A represents changes in input signals Rin, Gin, and Bin when H is 0. FIG. 16B represents changes in input signals Rin, Gin, and Bin when H is 120°. FIG. 16C represents changes in input signals Rin, Gin, and Bin when H is 220°. As shown in FIG. 16C, a unnatural color change greater than that of FIG. 13C is observed. The reason is because S2 in FIGS. 13A to 1CC is set to 0 when H is 220°, and to a value less than 0.5, as could be seen from FIG. 14B.

By way of summation and review, when image content having a wide color gamut according to a color space for UHDTV is provided to a display, the display having a typical color gamut, such as an sRGB color space or an Adobe RGB color space, may attempt to generate images having a wider color gamut. Thus, when a signal corresponding to a wide color gamut is input to such a display having a narrow color gamut, the display may use a color conversion technology to convert the wide color gamut into the narrow color gamut. However, the color reproduction region implemented may not match a color reproduction region defined according to a standard.

Color conversion methods have been proposed in attempt to accurately convert a wide color gamut into a narrow color gamut. These methods involve finding values for hue H, saturation S, and brightness V from input data and synthesizing an input data value with a data value obtained by converting the input data into the narrow color gamut according to the values to generate output data.

However, in these methods, data after the color conversion may not be included in a range (e.g., 0 to 1) originally predicted, but in this case may take a value less than 0 or greater than 1. This situation may be defined as an overflow phenomenon. When overflow occurs and a circuit operates, data is fixed to 0 when the data is equal to or less than 0 and the data is fixed to 1 when the data is equal to or greater than 1. Because an image is fixed to another value instead of a value to be originally changed, the image may not be accurately displayed.

In attempt to prevent this situation, the proposed methods have an S value under r=0.5 as a threshold value and change the threshold value according to the difference in color gamut between the wide color gamut and the narrow color gamut, when the synthesis ratio r of two data values is determined by the saturation S value. However, the color reproduction region implemented for each of a plurality of displays may not match a color reproduction region defined according to a standard using the proposed methods.

In accordance with one or more of the aforementioned embodiments, an image processing apparatus and method reduces or prevents an unnatural change in color even when a color reproduction region implemented for each of a plurality of displays does not match a color reproduction region defined by a standard.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. An image processing apparatus, comprising:
a signal input converter to convert input signals having a first color gamut representing image data to first image signals that are at least substantially linear;
a color gamut converter to convert the first image signals to second image signals having a second color gamut narrower than the first color gamut, the image signals having the second color gamut to be displayed;
a blend coefficient setter to set a blend coefficient corresponding to a synthesis ratio of the first image signals and the second image signals based on saturation obtained from the input signals; and
a color synthesizer to generate synthesized image signals obtained by synthesizing the first image signals and the second image signals at a ratio according to the set blend coefficient, wherein:
the blend coefficient setter is to set an upper bound of saturation based on a color difference between a boundary of the first color gamut and a boundary of the second color gamut and based on a chroma component of the boundary of the first color gamut, and
the blend coefficient setter is to set the upper bound of saturation when the boundary of the first color gamut and the boundary of the second color gamut are converted into an L*a*b space, the upper bound of saturation corresponding to when synthesized image signals generated by the color synthesizer based on the blend coefficient become the second image signals.

2. The apparatus as claimed in claim 1, wherein:
the blend coefficient setter is to set the upper bound of saturation according to a quotient, and
the quotient is to be obtained by dividing the color difference between the boundary of the first color gamut and the boundary of the second color gamut by the chroma component of the boundary of the first color gamut.

3. The apparatus as claimed in claim 1, wherein:
the blend coefficient setter is to decrease the upper bound of saturation under according to an increase in a quotient, and
the quotient is to be obtained by dividing the color difference between the boundary of the first color gamut and the boundary of the second color gamut by the chroma component of the boundary of the first color gamut.

4. The apparatus as claimed in claim 2, wherein:
a change rate of the upper bound of saturation to the quotient linearly varies,
under the upper bound of saturation, the synthesized image signals generated by the color synthesizer based on the blend coefficient become the second image signals.

5. The apparatus as claimed in claim 2, wherein:
before and after the upper bound of saturation, under which the synthesized image signals generated by the color synthesizer based on the blend coefficient become the first image signals, becomes 0.5,
a change rate of the upper bound of saturation, under which the synthesized image signals generated by the color synthesizer based on the blend coefficient become the second image signals, to the quotient is different.

6. An image processing method, comprising:
converting input signals having a first color gamut representing image data to first image signals that are at least substantially linear;
converting the first image signals to second image signals having a second color gamut narrower than the first color gamut, the second image signals having the second color gamut to be displayed;
setting a blend coefficient corresponding to a synthesis ratio of the first image signals and the second image signals based on saturation obtained from the input signals; and
generating synthesized image signals obtained by synthesizing the first image signals and the second image signals at a ratio according to a set blend coefficient, wherein:
an upper bound of saturation is to be set based on a color difference between a boundary of the first color gamut and a boundary of the second color gamut and based on a chroma component of the boundary of the first color gamut, and
the boundary of the first color gamut and the boundary of the second color gamut are to be converted into an L*a*b space, the an upper bound of saturation corresponding to when synthesized image signals generated based on the blend coefficient become the second image signals.

7. An image processing apparatus, comprising:
a signal input converter to convert input signals having a first color gamut to first image signals;
a color gamut converter to convert the first image signals to second image signals having a second color gamut narrower than the first color gamut;
a blend coefficient setter to set a blend coefficient corresponding to a synthesis ratio of the first and second image signals based on saturation obtained from the input signals; and
a color synthesizer to generate synthesized image signals obtained by synthesizing the first and second image signals at a ratio based on the blend coefficient, wherein:
the blend coefficient setter is to set saturation to a range based on a color difference between a boundary of the first color gamut and a boundary of the second color gamut and based on a chroma component of the boundary of the first color gamut, and
the blend coefficient setter is to set the saturation range when the boundary of the first color gamut and the boundary of the second color gamut are converted into a predetermined space, the saturation range corresponding to when synthesized image signals generated by the color synthesizer based on the blend coefficient become the second image signals.
